(19) United States
(12) Patent Application Publication
(10) Pub. No.: US 2009/0198641 A1
(43) Pub. Date: Aug. 6, 2009

(54) System and method for forecasting real-world occurrences

(75) Inventor: Vincent Tortoriello, West Caldwell, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Enforsys, Inc., Roseland, NJ (US)

(21) Appl. No.: 12/287,692

(22) Filed: Oct. 10, 2008

Related U.S. Application Data
(60) Provisional application No. 60/998,783, filed on Oct. 12, 2007.

(51) Int. Cl. G06N 7/02

(52) U.S. Cl. 706/52

(57) ABSTRACT

A method of predicting the occurrence of crime is provided, where information relating to prior transactions is provided, and where each transaction is a past incident where law enforcement units were involved. A set of analysis parameters relating to details associated with the incident may be selected and conditions associated with respective analysis parameters are selected. Further, at least one pivot variable may be selected, each pivot variable corresponding to one or more analysis parameters, and a frequency of the occurrence of the past incidents in relation to the pivot variables may be computed. Thus, a probability of a future incident occurring may be determined based on existence of a condition related to the pivot variable.

### CROSS-REFERENCE TO RELATED APPLICATIONS

This application claims the benefit of the filing date of U.S. Provisional Patent Application No. 60/998,783 filed Oct. 12, 2007, the disclosure of which is hereby incorporated herein by reference.

### BACKGROUND OF THE INVENTION

Typical forecast modeling is achieved through the use of linear regression or multiple regression analysis techniques. While this methodology is effective with linear data, it has limited capability beyond that, as its underlying assumption is that the relationship between variables is linear. For example, there may be a strong relationship between the occurrence of a crime and the number of law enforcement and public safety personnel involved at the scene. However, this relationship is of limited use for investigatory purposes, because a cause-and-effect relationship is not considered. Thus, a number of subtle relationships are present in real-world occurrences which are not accounted for with conventional forecast modeling.

Logical Analysis of Data (LAD) is a methodology for extracting knowledge from data by the systematic identification of patterns or “syndromes.” That is, LAD involves the detection of logical patterns which distinguish one observation from all other observations. A pattern characteristic for a specific class may be a combination of attribute values (or sets of values) occurring together only in some observations in class. The patterns may be used in explaining the results of classification to human experts by standard formal reasoning.

In operation, LAD uses observed data for which a positive or negative result is known, and provides predictions for data not in the set. However, such predictions may be inaccurate, because LAD is designed to handle classification problems involving only two classes. Many real life applications, in contrast, involve multiple classes. For example, crimes may occur during one of 24 hours in a day, 7 days in a week, on one of thirty different blocks in a neighborhood, and under numerous types of other conditions. Presently, a system and method for forecasting which accounts for such multiple classes of information is desired.

### SUMMARY OF THE INVENTION

One aspect of the present invention provides a computer-implemented method of forecasting, comprising providing data relating to prior transactions and determining a set of analysis parameters associated with details of the prior transactions. One or more conditions associated with respective analysis parameters may be provided via a user interface for forecasting the probability of a future event, and at least one pivot variable may be selected via the user interface. The pivot variable is also associated with one or more of the analysis parameters. Accordingly, a probability of a future event may be calculated based on a trend established in the occurrence of each prior transaction in relation to the pivot variable and existence of a condition related to the pivot variable.

A further aspect of the invention provides a system for forecasting incidents requiring law enforcement attention. This system includes an input device for receiving data relating to prior incidents requiring law enforcement attention, and for receiving user selections of variables. Further included is a processor for analyzing the data with respect to each of a set of selected analysis parameters associated with details of the prior incidents, and for calculating a probability of future incidents occurring based on a trend established in the occurrence of the prior incidents in relation to the selected variable and presence of the selected variable. Additionally, an output device may provide an indication of the probability to the user.

Yet another aspect of the present invention provides a computer-implemented method of predicting the occurrence of crimes. According to this method, information relating to prior transactions may be provided, where each transaction is a past incident where law enforcement units were involved. A set of analysis parameters relating to details of the incidents may also be provided via a user interface, along with one or more conditions associated with respective analysis parameters to forecast a probability of a future incident. At least one pivot variable associated with one or more of the analysis parameters may be selected via the user interface, and at least one probability of the future incident occurring based on a trend established in the occurrence of each prior transaction in relation to the pivot variable and existence of a condition related to the pivot variable may be calculated. The at least one probability may then be depicted in a display generated and presented to the user.

### BRIEF DESCRIPTION OF THE DRAWINGS

FIG. 1 is a system diagram according to an aspect of the invention.

FIG. 2 is system diagram according to another aspect of the present invention.

FIG. 3 is a user interface according to an aspect of the present invention.

FIG. 4 is data sample used in analysis according to an aspect of the present invention.

FIG. 5 is an output according to another aspect of the invention.

FIG. 6 is a screenshot of an output according to another aspect of the invention.

### DETAILED DESCRIPTION

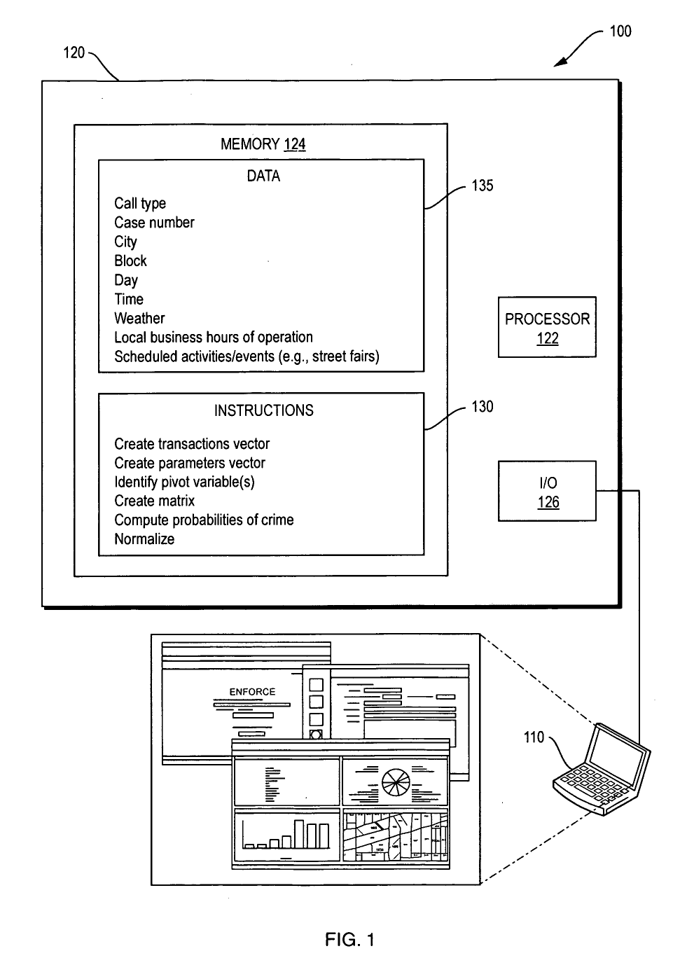

As shown in FIG. 1, a system 100 in accordance with one aspect of the invention comprises a user input and display device, such as a client computer 110, connected to a server computer 120. In accordance with one embodiment of the invention, the computer 120 includes a processor 122, memory 124, an input/output (I/O) interface 126, and other components typically present in general purpose computers.

Memory 124 stores information accessible by processor 122, including instructions 130 for execution by the processor 122 and data 135 which is retrieved, manipulated or stored by the processor 122. The memory 124 may be of any type capable of storing information accessible by the processor 122, such as a hard-drive, ROM, RAM, CD-ROM, write-capable, read-only, or the like.

The instructions 130 may comprise any set of instructions 130 to be executed directly (such as machine code) or indirectly (such as scripts) by the processor 122. In that regard, the terms “instructions,” “steps” and “programs” may be used interchangeably herein. The functions, methods and routines of the program in accordance with the present invention are explained in more detail below.

Data 135 may be retrieved, stored or modified by processor 122 in accordance with the instructions 130. The data 135 may be stored as a collection of data 135. For instance, although the invention is not limited by any particular data structure, the data 135 may be stored in computer registers, in a relational database as a table having a plurality of different fields and records, as an XML file. The data 135 may also be formatted in any computer readable format such as, but not limited to, binary values, ASCII or EBCDIC (Extended Binary-Coded Decimal Interchange Code), etc. Moreover, any information sufficient to identify the relevant data 135 may be stored, such as descriptive text, proprietary codes, pointers, or information which is used by a function to calculate the relevant data 135.

Although the processor 122 and memory 124 are functionally illustrated in FIG. 11 within the same block, it will be understood by those of ordinary skill in the art that the processor 122 and memory 124 may actually comprise multiple processors and memories that may or may not be stored within the same physical housing. For example, some or all of the instructions 130 and data 135 may be stored on removable CD-ROM and others within a read only memory. Some or all of the instructions 130 and data 135 may be stored in a location physically remote from, yet still accessible by, the processor 122. Similarly, the processor 122 may actually comprise a collection of processors which may or may not operate in parallel.

The client computer 110 may include components typically found in a computer system such as a display 112 (e.g., an LCD screen), user input 114 (e.g., a keyboard, mouse, touch-sensitive screen, voice recognition device), modem (not shown) (e.g., telephone or cable modem), and all of the components used for connecting these elements to one another. This computer 110 may be any device capable of processing instructions and transmitting data to and from humans and other computers, including but not limited to electronic notebooks, PDAs, and wireless phones.

The client computer 110 may communicate with the server computer 120 via any type of wired or wireless connection, such as radio frequency signals, microwave signals, or infrared signals. For example, the server computer 120 and client computer 110 may reside in different rooms of the same building and may be wired to one another via cable. According to another example, the client computer 110 may reside in a mobile unit, such as a police response vehicle, and communicate via wireless signal with the server computer 120, which may be stationed at a local police department. Although only one client computer 110 is depicted in FIG. 11, it should be appreciated that a typical system can include a large number of connected computers. The client computers 110 may communicate with the server computer 120 and with each other via the Internet, connecting to the Internet via modem or some other communication component such as a network card. For example, the server computer 120 may store data 135 for an entire city or state and may service every client computer 110 in that city or state.

Server computer 120 contains hardware for sending and receiving information over the Internet or World Wide Web, such as web pages or files. Server 120 may be a typical web server or any computer network server or other automated system capable of communicating with other computers over a network. Although the system 100 is described as including communications between client 110 and server 120 over the Internet, other embodiments are not limited to any particular type of network, or any network at all.

Although certain advantages are obtained when information is transmitted or received as noted above, other aspects of the invention are not limited to any particular manner of transmission of information. For example, in some aspects, the information may be sent via EDI (electronic data interchange) or some other medium such as a disk, tape, CD-ROM. The information may also be transmitted over a global or private network, or directly between two computer systems, such as via a dial-up modem. In other aspects, the information may be transmitted in a non-electronic format and manually entered into the system.

In addition to the operations illustrated in FIG. 1, an operation in accordance with a variety of aspects of the method will now be described. It should be understood that the following operations do not have to be performed in the precise order described below. Rather, various steps can be handled in reverse order or simultaneously. Moreover, many or all of the steps may be performed automatically, or manually as needed or desired.

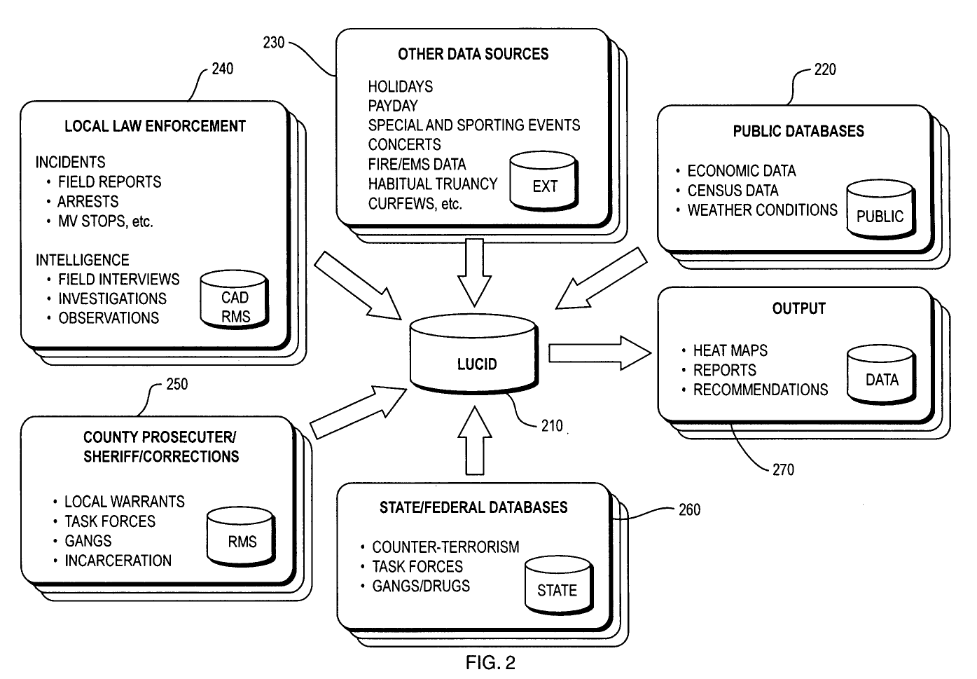

A method of predicting the occurrence of real-world events, such as crimes or other incidents requiring police response, may include assembling data relating to prior transactions. The prior transactions may be any of a number of types of real-world occurrences. For example, the transactions may be incidents reported to a police department, incidents where a person was arrested, or occurrences unrelated to law enforcement. Such data may be input directly by a user, or it may be assembled from one or more linked databases, as shown in FIG. 2. For example, the system may be linked to a database 210 maintaining records of all police calls or police reports entered by officers, and may extract data related to one or more calls (transactions). Data may also, or alternatively, be retrieved from various emergency response, law enforcement, and government databases 220-260. Examples of such databases are state/federal databases 260, including counter-terrorism, task-forces, and gangs/drugs information, county prosecutor/sheriff/corrections databases 250, including information regarding local warrants, task forces, gangs, and incarceration, and local law enforcement databases 240, including information relating to incidents (e.g., field reports, arrests, motor vehicle stops, etc.) and intelligence (e.g., field interviews, investigations, and observations). Examples of public databases 220 include economic data, census data, and weather conditions. Other potential data sources 230 include information relating to holidays, employment, payments, curfews, emergency services, education, and entertainment.

The assembled data may be organized in any manner to facilitate analysis. For example, the data may be presented in a transactional format where the particular call number and type may be listed, and all other data related thereto listed accordingly. The transactions may be arranged in any order, such as hierarchically, where transactions of a most severe type (e.g., homicide, rape) are arranged above less severe transactions (e.g., traffic violations).

A set of analysis parameters associated with details of the prior transactions may be selected. For example, analysis parameters may relate to time, location, type of incident, number of people involved in the incident, or weapons involved, or seemingly extraneous details such as weather during the incident. Source data or any other data sources that may be relevant to the analysis can be utilized as parameters for the analysis. For example, parameters may be defined for police dispatch history (e.g., deployment of units to particular areas, number of officers per patrol car, or number of units on patrol at a given time) and human resources data of a police department (e.g., rank, training, services, identification numbers, and assigned units of the individual officers).

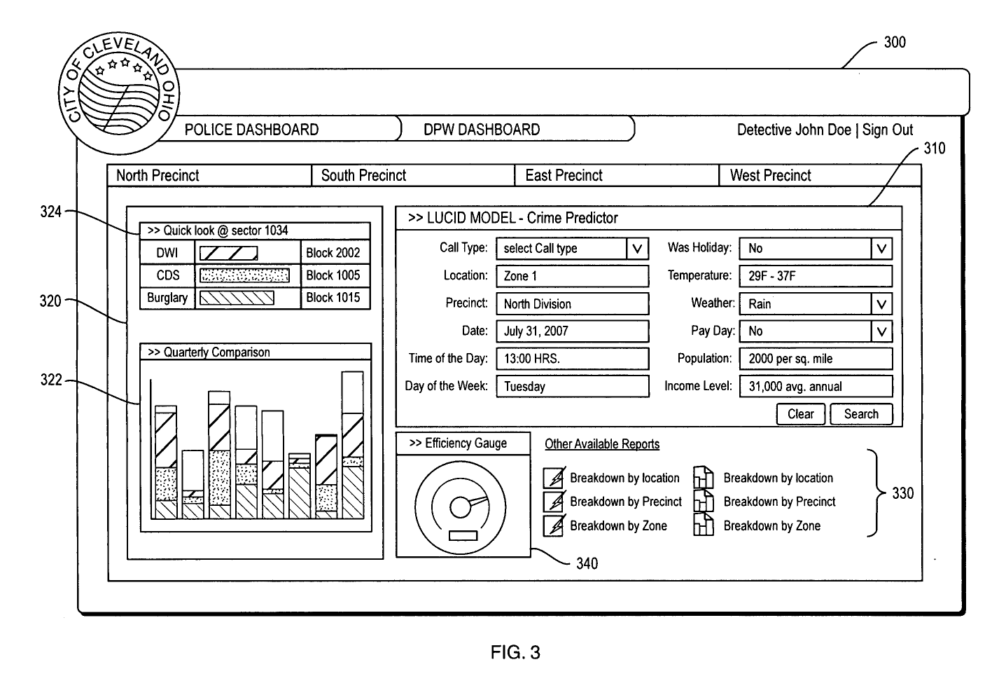

The parameters may be selected by a user for each forecast, or the parameters may be predefined for a series of forecasts. For example, as shown in FIG. 3, a user interface 300 may include a parameter input field 310 with a plurality of predefined categories of parameters (e.g., call type, location, precinct) to be specified by a user. As shown in FIG. 3, the input field 310 may include a plurality of drop-down menus and free text entry fields. However, other methods of data entry may also be used, such as voice recognition or “drag-n-drop” icons. Accordingly, the user may select specific parameters, such as Zone 1, or a range of parameters, such as 29-37 degrees F. The precision of the forecast may be improved by increasing the number and specificity of analysis parameters. Thus, for example, the interface 300 may include an efficiency gauge 340. According to one aspect, a reading on the efficiency gauge may correlate to the number of parameters selected.

The processor 122 may convert the analysis parameters into a series of closed-ended questions, such as “Did the incident occur between 1200-1300 hours?” or “Was it raining during occurrence of the incident?” The answers to each question, being either a yes or no, may be represented as a “1” for “yes” and a “0” for “no”. Accordingly, with respect to FIG. 3, the selection of “Zone 1” as location may result in a “1” for the parameter “Did the incident occur in Zone 1?” and a “0” for the parameters “Did the incident occur in Zone 2?; Did the incident occur in Zone 3?” and so on.

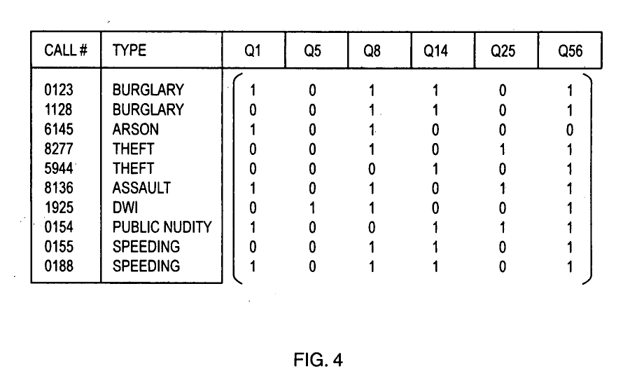

During the analysis process, based on the information being asked, a vector space matrix of data may be created. For example, a user may select particular parameters to consider, and the processor 122 may consider the data entered for those parameters as a matrix, as shown in FIG. 4. For example, because “Call type” is not selected in the input field 310, all call types are listed in column 410. However, because other parameters are specified, only the relevant parameters are included. That is, Q1, Q5, Q8, Q14, Q25, and Q25, may, for example, represent parameters such as “Did the incident occur in Zone 1?”; “Did the incident occur in the North Division?”; “Did the incident occur on a Tuesday?” etc. It should be understood that this data set is only exemplary, and that any number of parameters for any number or type of transactions may be used to create the matrix.

The user interface 300 allows the selection of one or more variables as a pivot variable, where each pivot variable is associated with at least one analysis parameter. For example, pivot variable input field 330 enables the user to select location, precinct, or zone as the pivot variable. Although only these variables are shown, it should be understood that any variable relating to the selected parameters may be used. Moreover, the pivot variable may be associated with more than one parameter. For example, the pivot variable “location” may relate to analysis parameters including “Did the incident occur on Smith Street?” and “Did the incident occur in New York City?” and “Did the incident occur within 5 miles of a high school?”

Based on the pivot variable, one or more trends may be established. For example, it may be established that incidents tend to occur within a predetermined radius of a playground, or that a particular type of incident tends to occur in a particular sector. Accordingly, such information may be used to calculate a probability of future incidents occurring relative to that pivot variable.

Thus, a series of steps may be performed by the processor 122 to create the forecast of crimes. First, the processor 122 may use information provided by the various databases 220-260 to build a master matrix. For example, each transaction is listed in a column, with each parameter listed in adjacent columns, similar to that shown with respect to FIG. 4. Accordingly, a series of 0s and is are provided across each row to provide details of the transaction. The master matrix may be minimized by deleting parameters which are irrelevant. That is, applying the equation

$${\sum }_{i = 1}^{t} {w}_{i} {y}_{i} \geq 1 \qquad Equation 1$$

where y is the conditional probability (i.e., either a 1 or a 0) and w is a weighting factor based on the volume of data (i.e., the number of parameters multiplied by the number of transactions), any column with a sum less than 1 (i.e., all “no” responses) may be deleted. In other words, as the elements are filled in the master matrix, the weight of each analysis parameter may be determined.

Accordingly, a minimum size of the master matrix may be represented by:

$$Min {\sum }_{i = 1}^{t} {y}_{i} \qquad Equation 2$$

From this point, a secondary matrix may be created using only parameters specified by a user. Thus, for example, while the master matrix may include millions of columns related to a vast array of parameters, the secondary matrix may include far fewer columns, each being related a parameter indicated by the user. Accordingly,

$${\sum }_{i = 1}^{t} {y}_{i} \geq 1 \qquad Equation 3$$

Simply put the value of each entry of the secondary matrix can take on the value of 0 or 1 but as long as only one of those values resides in each element.

Depending on the number of pivot variables selected, different equations may be used to forecast the data using the secondary matrix. For example, if one pivot variable is selected, the following equation may be applied to the secondary matrix:

$${\sum }_{i = 1}^{t} {y}_{i} \qquad Equation 4$$

In contrast, if multiple pivot variables are selected, the following equation may be used:

$${\sum }_{i = 1}^{{t}^{2}} \sqrt{Π {y}_{i , j}} \qquad Equation 5$$

Therefore, once all the columns of the secondary matrix are added, probabilities are calculated based on the totals. If more than one pivot variable is selected, calculations are performed for each pivot variable, and the results thereof are added.

The final results can be presented in a variety of visual displays or audio signals or other formats that allow one to quickly determine areas or factors that generate high probabilities or likelihood of occurrences.

One example of an output that may be provided to a user to indicate forecasted crimes is output 320 of FIG. 3. This output shows a graphical comparison 322 of the crime rates for three different crimes (driving while intoxicated (DWI), controlled dangerous substance (CDS), and burglary) for past quarters. It also shows a projection 324 for occurrence of these crimes for the day ahead. For example, as shown in projection 324, CDS is the crime most likely to occur, and it is most likely to occur on Block 1005.

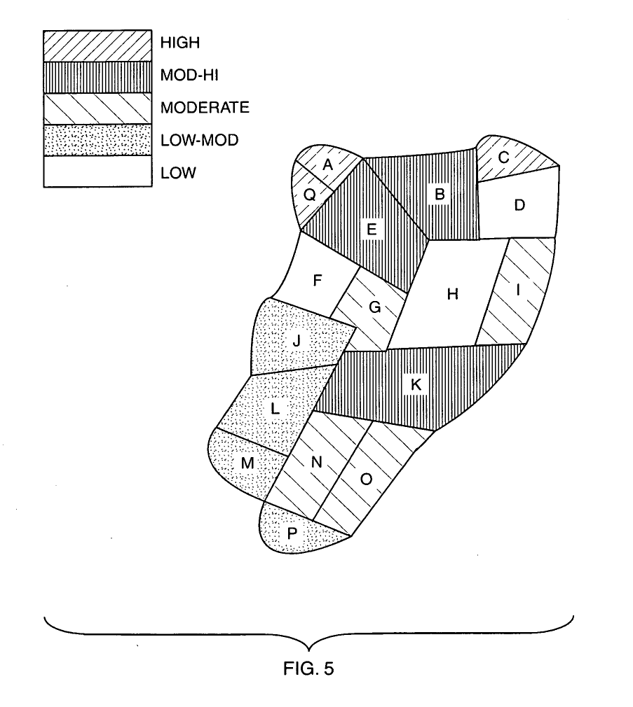

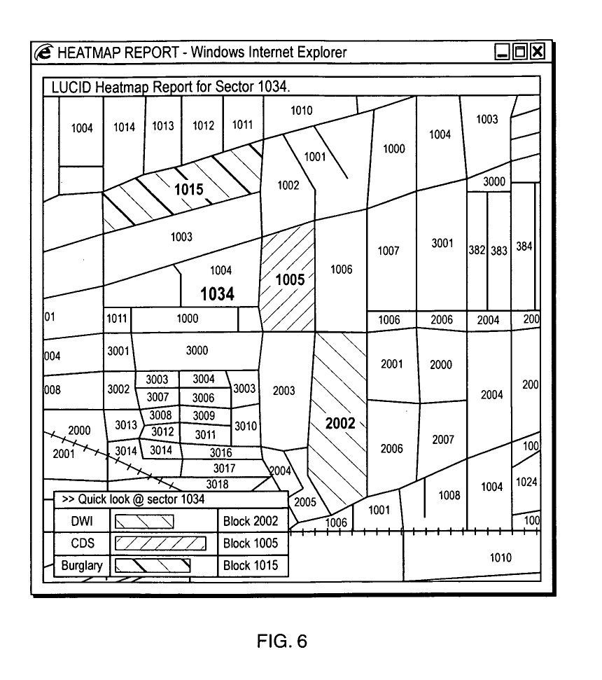

Another example of an output is a “heat map,” variations of which are shown in FIGS. 5-6. The heat maps account for historical trends and also show projected crime. Heat maps may identify “hot spots” by pattern or color coding to easily visualize areas having a high likelihood of an event occurring and areas having varying degrees of likelihood of the analyzed transactions (events) occurring. For example, as shown in FIG. 5, a representation of a monitored geographical area, such as a city, may be broken down into different sectors (e.g., A, E, D). The sectors with a high likelihood of crime occurring (e.g., Q, A, C) may be highlighted in a different pattern than those sectors with a low likelihood of criminal activity (e.g., F, H, D).

Using color, red on a map over a certain sector would mean that this area has the highest likelihood of an event occurring by these parameters and date range. Green would mean a very low likelihood exists that this type of criminal activity (transaction) would occur in this area. The color coding may correlate to the system used by the Department of Homeland Security, which ranges from red (most severe) to orange to yellow to blue to green (low risk). However, any number of levels can be established based on the level of granularity threshold desired.

As shown in FIG. 6, the display may be set to more specifically depict where crime is likely to occur, such as by breaking the city map into census blocks. Accordingly, within sector 1034, blocks 1015, 1005, and 2002 may be highlighted as having a high likelihood of criminal activity. Moreover, the type of criminal activity may also be indicated, for example, by a color coding scheme.

According to an embodiment of the present invention, law enforcement resources may be allocated in a manner that more closely mirrors the expected crime patterns. Time periods, weekends, weather conditions, and likelihood of types of crime may be incorporated into the forecast model to make better analytically based decisions. Police units may be deployed to high alert areas, or “Red Zones,” or projected crime sites. Similarly, less patrol units may be deployed to areas where crime is unlikely to occur. Accordingly, police presence in forecasted crime areas may deter crime, increase arrests, and ultimately increase public safety. Further, efficiency of the police may increase substantially.

According to one aspect of the invention, forecasts may be generated dynamically as data is retrieved from the one or more sources. Accordingly, police units may be deployed based on up to the minute information.

Some of the parameters used in the above-described analysis may be clearly relevant to forecasting the occurrence of future crimes or other incidents requiring police attention. For example, poverty levels, modus operandi (e.g., break in through basement window, murder using wire), gang activity data, drug activity data, and crime trends may be used to forecast future crimes with some degree of accuracy. However, other parameters which may be counterintuitive can increase this accuracy. For examples in addition to the search parameters used above, the system may consider additional data, including but not limited to weather conditions, demographics, calendar events (holidays), operating hours of various businesses, pay day, pay scale, sporting events (professional or local), property types, make up of the environment, scheduled postal/package deliveries school holidays, neighborhood special events, types of businesses in an area (e.g., office buildings, residences, delis), types of purchases or sales made at local establishments (e.g., pawning of firearms, purchase of chainsaw), concerts, entertainment districts, EMS calls, curfews, and habitual truancy.

A user may incorporate into the prediction method a parameter which has yet to be mapped. The logical progression of data mapping yields an output of probabilities which correspond to where and when future transactions are going to occur. One can choose any condition as the pivot variable to focus the data analysis. That is, the system may further include a pattern recognition analysis capability. This capability may be based on binary mathematics. For example, each transaction may be considered as a string, i.e., a series of “1”s and “0”s along the entire length of parameters listed. Each string may then be compared to determine similarities of certain parameters, enabling certain transactions to be identified and flagged for further study.

Accordingly, if a user would like to produce a crime forecast, but is unsure which parameters to select as the pivot variable(s), the system 100 may provide guidance to the user. For example, the system 100 may take each row of the master matrix and translate the string of binary digits into a text string. Each text string may be compared to the others, and groupings of strings that match or include a predetermined degree of similarity may be identified. For example, all text strings with greater than a threshold similarity (e.g., 80%) to one another may be identified as a group. From these groups a secondary matrix may be formed, the matrix indicating the likelihood of a crime occurring under similar conditions to the transactions in the matrix.

The methods described herein may apply not only to the public sector but in any field that collects data for the purpose of generating reports, output or analysis. These types of studies can assist in the decision making or resource management process, as well as aid the investigative process. Moreover, it may be used to forecast trends in fashion, movement of products in market, or rise/fall of investments. In this regard, the predictions may be based on a different set of parameters.

The system may be customized by each user in order to obtain predictions in a most readily understood format. For example, a user may change settings of the interface 300 to change the format of data input or output. While one user may prefer to view a list of potential crimes and their associated probabilities of occurring in a particular area, another user may prefer to view a geographic map with heat zones indicating the likelihood of crimes in particular regions.

Further, the system may be customized to provide specific types of forecasts. For example, when used as a tool for increasing public safety by forecasting crimes, the system may be customized to forecast only specific crimes, all crimes in a particular area, or crimes likely to occur on a specific calendar day.

Further aspects of the invention are described below with respect to Examples 1 and 2.

### Example 1

Data consisting of approximately two million transactions of various types were placed into a matrix, with each transaction as a record in column one. A header row consists of a set of parameters in adjacent columns (column 2, 3, 4 . . . n). For each transaction row, the individual parameter state consisted of a yes or no condition.

For each row, the parameter state (1=Yes; 0=No) based on the information supplied by the data from a city's CAD (Computer Aided Dispatch) system was placed in a corresponding column. The analysis using the described method continued for each month of the year, each day of the year, by time of day throughout the year. Additionally, the data was broken out into 28 sectors to simulate a city map. The pivot variable selected was Sector (location).

Using this master matrix, several call types were defined. A secondary matrix was extracted from the master matrix that only included rows corresponding to the transaction type(s) in the analysis. Values were then tabulated based on the summation in each column of that data that applied to each sector by date range.

The secondary matrix was then used to calculate a probability of each of the transaction types therein occurring in each sector. For this example, the time period within which the projected crimes were to occur was also limited. Thus, as seen from Table 1 and Table 2, separate forecasts were modeled for the 3^{rd} quarter 2008 and 3^{rd} quarter 2009, using data from the previous quarter.

Tables 1 and 2, below, indicate results for the application of the method of Example 1. The probabilities are calculated for each quarter of a year.

TABLE 1
Output Forecast Q3 2008: Based on Quarter Three, Year 2007

| REPORT FOR Q3: 2008 | | | NORMALIZED |
|---|---|---|---|
| SECTOR | COUNT | PERCENT | PERCENTAGE |
| 211 | 377 | 0.000085 | 11.4048034 |
| 212 | 480 | 0.0001379 | 18.5026164 |
| 213 | 218 | 0.0000284 | 3.8105461 |
| 214 | 525 | 0.0001649 | 22.1253187 |
| 215 | 177 | 0.0000187 | 2.5090568 |
| 216 | 545 | 0.0001777 | 23.8427479 |
| 217 | 419 | 0.0001051 | 14.101704 |
| 311 | 195 | 0.0000228 | 3.0591708 |
| 312 | 73 | 0.0000032 | 0.4293573 |
| 313 | 123 | 0.0000091 | 1.2209848 |
| 314 | 176 | 0.0000185 | 2.4822219 |
| 315 | 271 | 0.0000439 | 5.8902455 |
| 316 | 285 | 0.0000486 | 6.5208641 |
| 317 | 47 | 0.0000013 | 0.1744264 |
| 411 | 451 | 0.0001217 | 16.328995 |
| 412 | 345 | 0.0000712 | 9.5532001 |
| 413 | 339 | 0.0000688 | 9.2311821 |
| 414 | 331 | 0.0000656 | 8.8018248 |
| 415 | 241 | 0.0000348 | 4.6692607 |
| 416 | 1116 | 0.0007453 | 100 |
| 417 | 646 | 0.0002497 | 33.5032873 |
| 511 | 511 | 0.0001563 | 20.9714209 |
| 512 | 584 | 0.0002041 | 27.3849457 |
| 513 | 346 | 0.0000716 | 9.6068697 |
| 514 | 215 | 0.0000277 | 3.7166242 |
| 515 | 597 | 0.0002133 | 28.6193479 |
| 516 | 225 | 0.0000303 | 4.065477 |
| 517 | 362 | 0.0000784 | 10.519254 |

TABLE 2
Output Forecast Q3 2009: Based on Quarter Three, Year 2008

| REPORT FOR Q3: 2009 | | | NORMALIZED |
|---|---|---|---|
| SECTOR | COUNT | PERCENT | PERCENTAGE |
| 211 | 617 | 0.0002093 | 21.9783682 |
| 212 | 596 | 0.0001953 | 20.5082432 |
| 213 | 324 | 0.0000577 | 6.059015 |
| 214 | 652 | 0.0002338 | 24.5510868 |
| 215 | 180 | 0.0000178 | 1.8691589 |
| 216 | 483 | 0.0001283 | 13.4726452 |
| 217 | 459 | 0.0001159 | 12.1705345 |
| 311 | 158 | 0.0000137 | 1.4386223 |
| 312 | 60 | 0.000002 | 0.2100179 |
| 313 | 174 | 0.0000166 | 1.7431482 |
| 314 | 128 | 0.000009 | 0.9450803 |
| 315 | 326 | 0.0000584 | 6.1325213 |
| 316 | 320 | 0.0000563 | 5.9120025 |
| 317 | 69 | 0.0000026 | 0.2730232 |
| 411 | 302 | 0.0000502 | 5.2714481 |
| 412 | 381 | 0.0000798 | 8.3797123 |
| 413 | 249 | 0.0000341 | 3.5808044 |
| 414 | 300 | 0.0000495 | 5.1979418 |
| 415 | 310 | 0.0000528 | 5.5444713 |
| 416 | 1316 | 0.0009523 | 100 |
| 417 | 577 | 0.0001831 | 19.2271343 |
| 511 | 544 | 0.0001627 | 17.0849522 |
| 512 | 545 | 0.0001633 | 17.1479576 |
| 513 | 319 | 0.000056 | 5.8804998 |
| 514 | 218 | 0.0000261 | 2.740733 |
| 515 | 438 | 0.0001055 | 11.0784417 |
| 516 | 238 | 0.0000311 | 3.2657776 |
| 517 | 378 | 0.0000786 | 8.2537016 |

Accordingly, as seen in Table 2, when output data of the calculated probabilities is normalized for the purposes of identifying “hot spots,” the highest likelihood of crime occurring is in sector 416. The next highest likelihood of a crime occurring would be in sector 214. This ascending order of probabilities may be used to generate the heat maps as discussed previously.

### Example 2

Data relating to burglary transactions for the year 2007 is extracted from the master matrix and used to form the secondary matrix, as shown below. The parameters selected include time of day (shown in military time), location (zones), and day of the week (Monday-Thursday). This data may be extracted from the master matrix in a variety of ways. For example, a user may select the desired transactions and parameters from drop down menus, a user may enter a search term for which all matching parameters or transactions will be flagged, or a user may select the desired data fields and drag them into a new matrix. The fields may also be automatically selected by a processor, either randomly or pursuant to an algorithm.

| Sample Matrix | | | | | | | | | | | |
|---|---|---|---|---|---|---|---|---|---|---|---|
| Calculation: | | | | | | Pivot | | | | | |
| Call | | T: | T: | T: | | Variable | | | | | |
| Type | Transaction | 1300 | 1400 | 1500 | Zone 1 | Zone 2 | Zone 3 | Mon | Tue | Wed | Thur |
| Burglary- | 1 | 1 | 0 | 0 | 0 | 0 | 1 | 1 | 1 | 0 | 0 |
| 2007- | | | | | | | | | | | |
| 12345 | | | | | | | | | | | |
| Burglary- | 2 | 0 | 1 | 0 | 0 | 1 | 1 | 0 | 1 | 1 | 0 |
| 2007- | | | | | | | | | | | |
| 22345 | | | | | | | | | | | |
| Burglary- | 3 | 0 | 0 | 1 | 1 | 1 | 0 | 0 | 0 | 1 | 0 |
| 2007- | | | | | | | | | | | |
| 34527 | | | | | | | | | | | |
| Burglary- | 4 | 0 | 0 | 1 | 0 | 1 | 0 | 1 | 0 | 0 | 1 |
| 2007- | | | | | | | | | | | |
| 47222 | | | | | | | | | | | |
| Burglary- | 5 | 0 | 1 | 1 | 0 | 1 | 0 | 0 | 0 | 1 | 0 |
| 2007- | | | | | | | | | | | |
| 54784 | | | | | | | | | | | |
| Burglary- | 6 | 1 | 0 | 0 | 0 | 0 | 1 | 1 | 0 | 0 | 0 |
| 2007- | | | | | | | | | | | |
| 68595 | | | | | | | | | | | |
| Burglary- | 7 | 1 | 1 | 1 | 1 | 1 | 0 | 1 | 0 | 1 | 0 |
| 2007- | | | | | | | | | | | |
| 77777 | | | | | | | | | | | |
| | Sums | 3 | 3 | 4 | 2 | 5 | 3 | 4 | 2 | 4 | 1 |

According to the above example, only one pivot variable is selected. Specifically, the designated pivot variable is “location,” for which parameters “Zone 1,” “Zone 2,” and “Zone 3” provide the relevant information. Accordingly, for each of these pivot variable parameters, the following calculation is performed:

Probability Equation: (Mᵢ(Σxᵢ+Σyᵢ)/((Mᵢ(ΣAᵢ+ΣBᵢ+ΣCᵢ+ . . . ΣDᵢ₊₁))−Σni))

### Wherein:

Mᵢ Scaling factor equaling a number of rows per column
Σxᵢ Summation for a selected question of Pivot Variable
ΣAᵢ Summation of a particular column of Non-Pivot Variable
Σyᵢ Second Pivot Variable summation—in this case zero (0)—not needed for one pivot variable calculations
Σnᵢ Summation of all other Pivot Variable Question answers (in this case location indicators) not included in numerator

Accordingly, for pivot variable “location” the calculation for Zone 1 would be:

2/((3+3+4+4+2+4+1)−(5+3))=0.1007

The numerator of the equation contains the number of “yes” answers to the selected question. The denominator contains the sum of all other values for each non-pivot variable column, less the sum of the other pivot variable parameters (Zone 2 and Zone 3).

The calculation may then be performed for the rest of the pivot variable parameters, Zone 2 and Zone 3. The results of such calculations for the exemplary data are shown below:

| Pivot | |
|---|---|
| Variable | Probability |
| Zone 1 | 0.100719424 |
| Zone 2 | 0.246478873 |
| Zone 3 | 0.15 |

The probabilities may be normalized, for example, to facilitate display of the probabilities on a heat map. The largest value of all the probability results (in this example Zone 2) is used to divide the results for each other zone. This will now scale the results from 1 to 0, or 100% to 0%. The percentage values may be used to generate heat maps ranging in color from Red to Green based on the percent probability calculated and normalized.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method of forecasting, comprising:
providing data relating to prior transactions;
providing a user-interface with a set of analysis parameters, the analysis parameters being associated with details of the prior transactions;
providing one or more conditions via the user interface associated with respective analysis parameters to forecast a probability of a future event;
selecting via the user interface at least one pivot variable, the pivot variable being associated with one or more of the analysis parameters;
calculating at least one probability of a future event based on a trend established in the occurrence of each prior transaction in relation to the pivot variable and existence of a condition related to the pivot variable.

2. The method of claim 1, further comprising providing a representation of the at least one probability to a user.

3. The method of claim 2, wherein the at least one probability is displayed in relation to a map.

4. The method of claim 2, wherein the at least one probability is displayed in relation to a predetermined time.

5. The method of claim 1, further comprising allocating resources in relation to the at least one probability of the occurrence of the event.

6. The method of claim 5, wherein allocating resources includes dispatch of law enforcement units.

7. The method of claim 1, wherein the transactions are reports of crimes or disturbances.

8. The method of claim 1, wherein the analysis parameters include a series of questions.

9. The method of claim 8, wherein the questions relate to one of time, location, nature, or surrounding conditions of the event.

10. The method of claim 1, wherein the step of providing data is performed by one or more external linked databases.

11. A system for forecasting incidents requiring law enforcement attention, comprising:
an input device for receiving data relating to prior incidents requiring law enforcement attention, and for receiving user selections of variables;
a processor for analyzing the data with respect to each of a set of selected analysis parameters, the analysis parameters being associated with details of the prior incidents, and for calculating a probability of future incidents occurring based on a trend established in the occurrence of prior incidents in relation to the selected variable and presence of the selected variable; and
an output device for providing an indication of the probability to the user.

12. The system of claim 11, wherein the output device is a display.

13. The system of claim 11, wherein the input device is connected to at least one external database.

14. The system of claim 11, further comprising a wireless transmission unit for transmitting the information to a mobile device.

15. A computer-implemented method of predicting the occurrence of crimes, comprising:
providing information relating to prior transactions, where each transaction is a prior incident where law enforcement units were involved;
providing a user interface with a set of analysis parameters, the parameters relating to details associated with the prior incident;
providing one or more conditions via the user interface associated with respective analysis parameters to forecast a probability of a future incident;
selecting via the user interface at least one pivot variable, the pivot variable being associated with one or more of the analysis parameters;
calculating at least one probability of the future incident occurring based on a trend established in the occurrence of each prior transaction in relation to the pivot variable and existence of a condition related to the pivot variable; and
generating a display depicting the at least one probability of the future incident.

16. The method of claim 15, wherein the analysis parameters comprise a series of closed-ended questions.

17. The method of claim 16, wherein the questions relate to location, time, and nature of the past incident.

18. The method of claim 15, wherein the questions relate to events scheduled for or occurring around a time of the past incident.

19. The method of claim 16, further comprising dispatching law enforcement units in response to the at least one calculated probability.
